(19) United States
(12) Patent Application Publication
(10) Pub. No.: US 2017/0219071 A1
(43) Pub. Date: Aug. 3, 2017

(54) Linear Actuator with Electro-mechanical Brake and Slip Clutch

(71) Applicants: Edwin Stephens Gurdjian, Union City, PA (US); Carol Frances Maxwell, Union City, PA (US)

(72) Inventors: Edwin Stephens Gurdjian, Union City, PA (US); Carol Frances Maxwell, Union City, PA (US)

(21) Appl. No.: 15/012,893

(22) Filed: Feb. 2, 2016

(51) Int. Cl. F16H 25/24; F16H 25/20; F16H 25/22

(52) U.S. Cl. CPC F16H 25/2454; F16H 25/2204; F16H 25/2025; F16H 2025/2071; F16H 2025/2084; F16H 2025/2062

(57) ABSTRACT

A linear actuator with an electric motor at one end and an electro-mechanical brake at the other, which is used to deploy and retract expandable rooms of recreational vehicles. When power is applied to the electro-mechanical brake, the leadscrew freewheels and allows manual compression of the actuator to return the expandable room to its highway travel position.

### BACKGROUND OF THE INVENTION

In recent decades, recreational vehicles have incorporated expandable rooms, often referred to as slide modules, slides, or slide-outs. The expandable feature increases the interior space while parked and yet maintains legal size requirements while in motion. The increased interior space allows manufacturers to include many desirable amenities to satisfy consumer preferences. Various methods have been used to deploy and retract the slide modules, including a single or plurality of hydraulic cylinders, electric motors, chains, belts, screws, or linear actuators. When a manufacturer uses a plurality of devices, various methods may be used to synchronize the devices. The motion of the slide modules can be impacted by distortion of the structures, failure of the mechanism(s) and/or its component(s), loss of power, or other factors. In some cases, there is no way to release the devices without significant disassembly. When the expandable room(s) become jammed in a deployed position and cannot be retracted, the vehicle cannot be driven on public highways. If the issue can be resolved on-site, the process of disconnecting the system can be expensive. If the issue cannot be resolved on site, then the vehicle may have to be transported via truck as an over-size load to a repair facility, which can add significant cost.

BRIEF SUMMARY OF THE INVENTION

The present invention uses one or more dual motor electric actuator(s) to move the slide module(s) of a recreational vehicle in and out. The actuator(s) have a mechanical release feature that can be employed in emergency situations to allow manual repositioning of the slide module(s).

### BRIEF DESCRIPTION OF THE SEVERAL VIEWS OF THE DRAWINGS

FIG. 1: is a section view of the components of a dual motor linear actuator with an electro-mechanical brake/slip clutch.

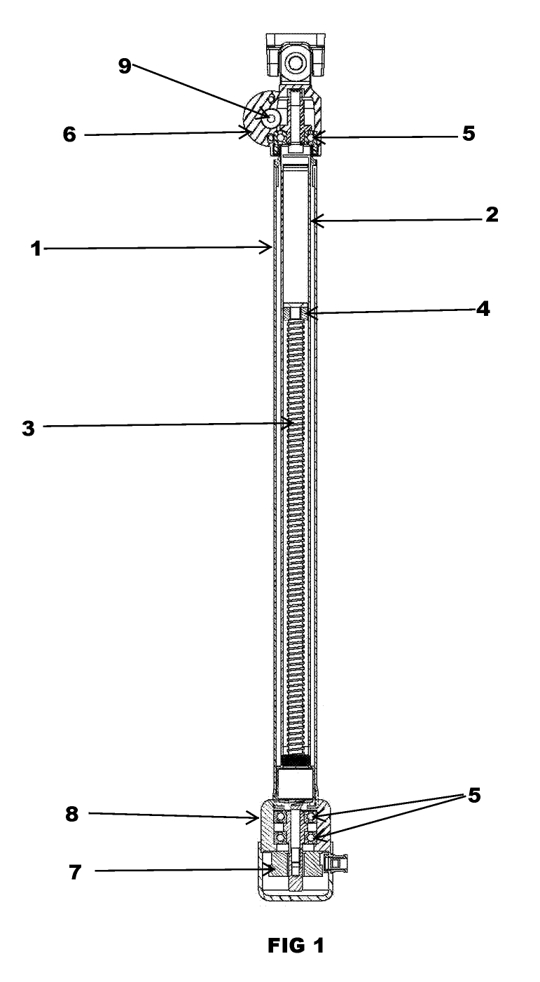

### DETAILED DESCRIPTION OF THE INVENTION

This actuator design is comprised of an outer tube 1, an inner tube 2, a leadscrew 3, a ballnut 4, support bearings 5, an electric drive motor 6 at one end, and an electro-mechanical brake/slip clutch 7 at the other.

The outer tube 1, which extends the length of the compressed actuator is attached to the electro-mechanical brake housing 8 and does not rotate. The inner tube 2 is connected to the drive motor 6 by appropriate gears 9, supported by bearing(s) 5, and rotates within the outer tube 1. The leadscrew 3 is supported by the ballnut 4 at the motor 6 end, and a bearing 5 at the brake 7 end of the inner tube 2. The ballnut 4 is securely attached to the inside wall of the inner tube 2 and rotates on the leadscrew 3 as the inner tube 2 turns. When not energized, the electro-mechanical brake 7 holds the leadscrew 3 stationary and allows the actuator to extend as the ballnut 4 rotates and moves along the leadscrew 3.

If motion is obstructed, the electro-mechanical brake 7 functions as a slip clutch 7. The brake 7 holding force will be overcome by the motor/gearbox 6/9 torque, and the brake 7 will slip and thus prevent damage to the vehicle chassis or the actuator assembly. When power is applied to the electro-mechanical brake 7, the leadscrew 3 freewheels and allows manual or mechanical retraction of the actuator. In this condition, pushing on the slide module, collapses the actuator and returns the slide out assembly to its highway travel position.

Although the principles, embodiments, and operation of the present invention have been described in detail herein, this is not to be construed as being limited to the particular illustrative forms disclosed. It will thus become apparent to those skilled in the art that various modifications of the embodiments herein can be made without departing from the spirit or scope of the invention.

We claim:

1. An actuator used to deploy and retract expandable rooms of recreational vehicles, which is comprised of an outer tube, an inner tube, an electric drive motor, a leadscrew, a ballnut, support bearings, and an electro-mechanical brake.

2. In the actuator of claim 1, the outer tube extending the length of the actuator is attached to the electro-mechanical brake housing and does not rotate; the electric drive motor and the brake are on opposite ends of the actuator; the inner tube is rotated by the drive motor using appropriate gears and supported by bearings; the ballnut is attached to the inside wall of the inner tube and rotates on the leadscrew; and the leadscrew is supported by the ballnut at the motor end, and a bearing at the brake end of the inner tube.

3. The actuator of claim 1 contains an electric brake which acts as both a release mechanism when energized and a slip clutch, when not energized; therefore, when an obstruction is encountered, the brake holding force will be overcome by the motor/gearbox torque, and it will slip to prevent mechanical damage; whereas when power is applied to the brake, the leadscrew is released and allowed to spin in the support bearings and the actuator can be collapsed by pushing on the actuator, thereby returning the slideout assembly to the highway travel position.
